(19) United States
(12) Patent Application Publication
(10) Pub. No.: US 2021/0041827 A1
(43) Pub. Date: Feb. 11, 2021

(54) BODY STRUCTURE OF IMAGE FORMING APPARATUS AND IMAGE FORMING APPARATUS

(71) Applicants: Junichi MURANO, Saitama (JP); Hiroki ISHIMITSU, Kanagawa (JP); Taisuke ISHIKAWA, Kanagawa (JP)

(72) Inventors: Junichi MURANO, Saitama (JP); Hiroki ISHIMITSU, Kanagawa (JP); Taisuke ISHIKAWA, Kanagawa (JP)

(73) Assignee: Ricoh Company, Ltd., Tokyo (JP)

(21) Appl. No.: 16/942,097

(22) Filed: Jul. 29, 2020

(30) Foreign Application Priority Data
Aug. 9, 2019 (JP) 2019-148058

(51) Int. Cl. G03G 21/16

(52) U.S. Cl. CPC G03G 21/1619; G03G 2221/1684; G03G 2221/1654; G03G 21/1661

(57) ABSTRACT

A body structure of an image forming apparatus, which includes a printer, a reader, and a paper processing unit located between the printer and the reader, includes a housing for the paper processing unit, independently provided above a housing of the printer.

### CROSS-REFERENCE TO RELATED APPLICATIONS

The present application claims priority under 35 U.S.C. § 119 to Japanese Patent Application No. 2019-148058, filed on Aug. 9, 2019. The contents of which are incorporated herein by reference in their entirety.

### BACKGROUND OF THE INVENTION

### 1. Field of the Invention

The present invention relates to a body structure of an image forming apparatus, and an image forming apparatus.

### 2. Description of the Related Art

Conventionally, a body structure of an image forming apparatus including a printer, a reader, and a paper processing unit located between the printer and the reader has been known.

For example, a punching unit, a turnover unit, and/or a post-processing unit, as examples of the paper processing unit, are placed in-between a printer and a reader (described in Japanese Unexamined Patent Application Publication No. 2010-85431, for example).

Image forming apparatuses may include no paper processing units or include paper processing units having mutually different heights. It is preferable that such image forming apparatuses include printers with the same specifications and have an overall height according to the height of paper processing units.

### SUMMARY OF THE INVENTION

According to one aspect of the present invention, a body structure of an image forming apparatus, which includes a printer, a reader, and a paper processing unit located between the printer and the reader, includes a housing for the paper processing unit, independently provided above a housing of the printer.

### BRIEF DESCRIPTION OF THE DRAWINGS

FIG. 1 is a schematic diagram of a structure of an electrophotographic copier;

FIG. 2 is a perspective view of a body structure of the copier;

FIG. 3 is a perspective view of a front side plate of a printer;

FIG. 4A is a perspective view illustrating the bottom part of a front-right side plate of a finisher;

FIG. 4B is a perspective view of the top part of the front side plate of the printer;

FIG. 5 is a perspective view illustrating a structure of an existing model including no finisher function;

FIG. 6A is a perspective view illustrating the bottom part of a scanner table;

FIG. 6B is a perspective view illustrating the top part of a front-right side plate of a finisher;

FIG. 7 is a perspective view illustrating the copier without an exterior cover, contacting a scanner unit;

FIG. 8 is an enlarged view of near an area between a front-left side plate and the front-right side plate of the finisher; and

FIG. 9 is a schematic diagram of a structure of a post-processing unit.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of the present invention is to provide a body structure of an image forming apparatus including a printer, a reader, and a paper processing unit located between the printer and the reader, the body structure including a housing for the paper processing unit, independently provided above a housing of the printer.

The following will describe an embodiment of a body structure of a copier to which the present invention is applied. The copier is an exemplary image forming apparatus.

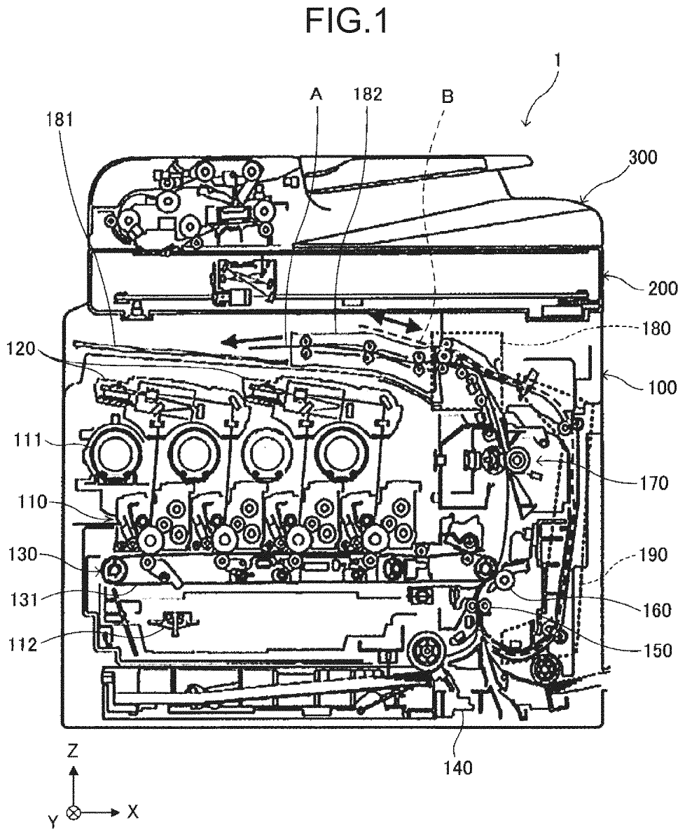

FIG. 1 is a schematic diagram illustrating a structure of an electrophotographic copier. A copier 1 includes a printer 100, a scanner unit 200 serving as a reader located above the printer, and an automatic document feeder (ADF) 300 located above the scanner unit 200. The automatic document feeder 300 feeds a document and the scanner unit 200 reads the document to generate an image signal. The printer 100 forms an image on a sheet of paper in accordance with the image signal. The printer 100 includes four-color (yellow, magenta, cyan, and black) image forming units 110 each incorporating a photoconductor serving as an image bearer, a charging device, a developing device, and a cleaning unit. A writing unit 120 exposes the photoconductor with light to form a latent image thereon, and the developing device visualizes the latent image to form a toner image on the photoconductor. The toner image of the four colors is temporarily transferred onto an intermediate transfer belt 131 of an intermediate transfer unit 130 in a superimposed manner.

During single-sided feeding, as indicated by the solid line A, a paper sheet is conveyed through a registration roller 150 from a paper tray 140 serving as a paper container and the toner image is transferred onto the paper sheet by a second transfer roller 160 and fixed by a fixing unit 170. A finisher unit 182, serving as a paper processing unit, is located between a paper ejection unit 180 and a paper ejection tray 181 to subject the paper sheet to post processing, such as sorting and stapling. The sheet is then output to the paper ejection tray 181. This copier is of an internal paper ejection type and outputs sheets of paper to the space between the printer 100 and the scanner unit 200. The finisher unit 182 is located between the printer 100 and the scanner unit 200 in the copier.

During double-sided feeding, after the toner image is transferred onto a paper sheet by the second transfer roller 160 and fixed by the fixing unit 170 as in the single-sided feeding, the paper sheet is conveyed from the paper ejection unit 180 to the finisher unit 182 as indicated by the broken line B, and ejected and reversed at the top part of the finisher unit 182. The paper sheet then passes through a double-side unit 190 and is transferred again from the registration roller 150 to the second transfer roller 160, to transfer the image on the rear side of the sheet and fix it thereon by the fixing unit 170. The paper sheet is then subjected to sorting or stapling in the finisher unit 182 for ejection to the paper ejection tray 181. The copier as illustrated also includes four-color toner bottles 111 that contain toner to be supplied to the developing device, and a waste toner bottles 112 for all the colors.

To develop an upgraded, new model by adding a finisher as a paper processing unit to a released or developed existing model in-between a printer and a reader, a new housing that holds the finisher in addition to an image bearer, a fixing device, a transfer device, and a registration roller is generally manufactured, as with the existing models. The same applies to development of another model that can additionally include a developed unit such as a finisher, for a particular model. Such housing is required to accurately hold the image bearer, the fixing device, the transfer device, the registration roller, and the paper feeder device. A technique of holding such devices including the finisher with a single side plate is known, as described in Japanese Unexamined Patent Application Publication No. 2010-85431, for example.

However, to create a new model without using a structure of an existing model, a new structure sufficient for accurately holding the image bearer, the fixing device, and other devices is to be created again. This requires time and cost to manufacture accurate parts and components. For different models which adopt paper processing units having different heights and printers with the same specifications, a body structure holding the respective devices is to be a single side plate that can hold the paper processing unit having a highest height. This causes an unnecessarily large space between the printer and the scanner unit in a model including a paper processing unit of a relatively low height, causing an unnecessary increase in height of the image forming apparatus as a whole.

In view of this, the present embodiment is intended to not create a new housing requiring accuracy but use the housing of an existing model, enabling the height of the overall image forming apparatus to be set according to the height of a paper processing unit to be included therein. Thus, the body structure includes a housing for the finisher unit 182, serving as a paper processing unit, independently from the housing of the printer. The housing of the finisher unit 182 is placed above the housing of the printer.

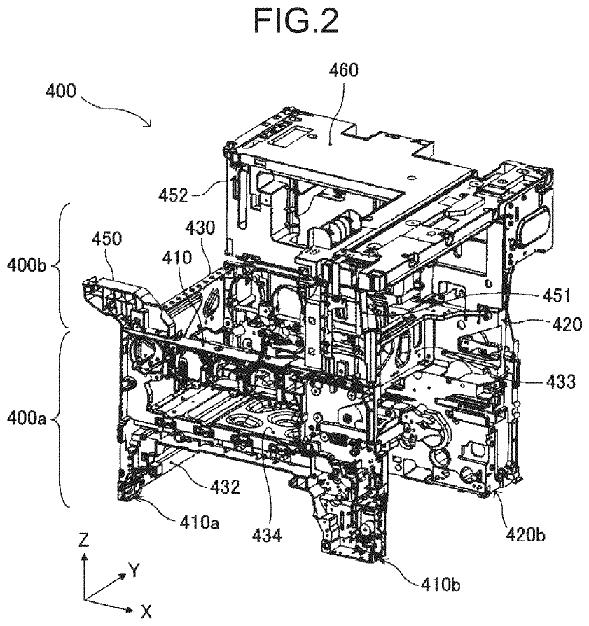

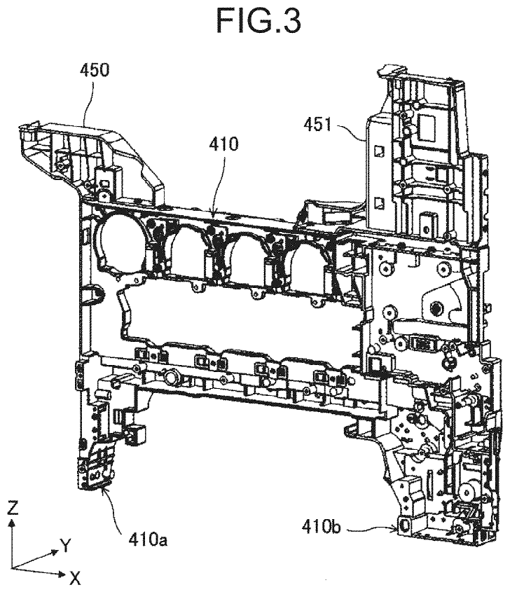

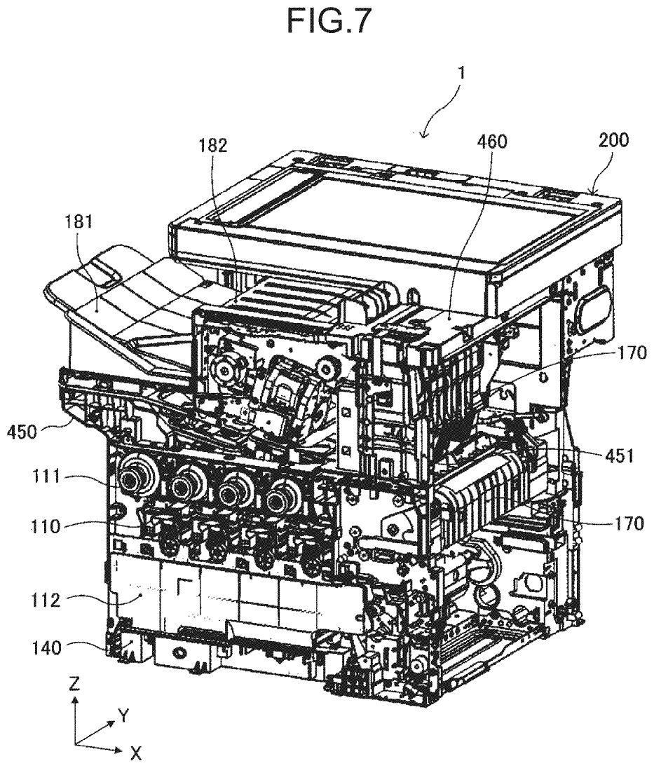

FIG. 2 is a perspective view of a body structure 400 of the copier 1. FIG. 3 is a perspective view of a front side plate 410 of the printer, a front-left side plate 450 of the finisher located on the front side plate 410, and a front-right side plate 451 of the finisher. A finisher structure 400b serves as the housing of the finisher unit 182 and is placed above a printer structure 400a serving as the housing of the printer. The scanner unit 200, as illustrated in FIG. 1, is placed above the finisher structure 400b (refer to FIG. 7). The automatic document feeder 300 is placed above the scanner unit 200 (refer to FIG. 1). The printer structure 400a includes a front side plate 410 and a rear side plate 420 coupled together through stay members. The stay members include an upper-left stay member 430, a lower-left stay member 432, a fixing stay member 433, and a base member 434.

To ensure the flatness of a color copier, i.e., accurate height of the respective units, for the purpose of color shift prevention, the copier is preferably installed at three points. In the present embodiment, a left foot 410a at a left end of the front side plate 410 does not touch the floor. The copier is installed at three points in total, that is, the bottoms of both right and left feet (right foot 420b) at both ends of the rear side plate 420, and the bottom of a right foot 410b on the right end of the front side plate 410.

The finisher structure 400b includes the front-left side plate 450 located upper left of the front side plate 410, the front-right side plate 451 located upper right of the front side plate 410, a rear side plate 452 located above the rear side plate 420 of the printer, a scanner table 460 located above the front-right side plate 451 and the rear side plate 452. Among them, the scanner table 460 functions as a stay member to couple the front-right side plate 451 and the rear side plate 420.

The paper ejection unit 180 is placed between the front-right side plate 451 and the rear side plate 420, in addition to the finisher unit 182 (refer to FIG. 1). The finisher unit 182 and the paper ejection unit 180 include inside a side plate pair that supports both ends of a rotational element, such as a roller. The side plate pair is connected to the front-right side plate 451 and the rear side plate 420. These units have rigidity sufficient to maintain the parallelism of the rotational element, and function also as stay members to connect the front-right side plate 451 and the rear side plate 420. The front-right side plate 451 is coupled to the rear side plate 420 through a member of the paper ejection tray 181, for example, as illustrated in FIG. 7.

As described above, the finisher structure 400b is placed above the printer structure 400a. In the case of such a printer structure 400a being an existing model released or developed, to develop an upgraded, new model additionally including a function such as a finisher, it is not necessary to create new front and rear side plates to hold an image bearer, a fixing device, a transfer device, and a registration roller. Instead, it is made possible to provide a body structure that can accurately hold the finisher in addition to the image bearer, the fixing device, the transfer device, and the registration roller, by placing the front and rear side plates dedicated to holding the finisher above the front and rear side plates of the structure of the existing model. This leads to shortening a developing period and reducing the manufacturing cost of new side plates.

Moreover, the finisher structure is set to a desired height and installed on the printer structure 400a. Thereby, the height of the overall copier incorporating the scanner unit 200 above the finisher structure can also be set to a desired height. A unit having a height different from the height of the finisher unit 182 serving as a paper processing unit can be placed between the printer and the reader in the same manner. Thereby, the copier can be set to a desired height by placing the front and rear side plates dedicated for holding the unit in accordance with the height of the unit.

In the copier of the present embodiment, the scanner table 460 can be maintained in surface levelness equal to that of an existing model without a finisher function since the surface on which the scanner is installed is to be accurately flat. For this purpose, the copier includes the following structure. The joint of the printer side plates of the existing model to the scanner table is used for the joint part of the printer front and rear side plates to the finisher front and rear side plates to add. To join to the joint of the printer side plates of the existing model, the joint of the finisher side plate to add adopts the same or like structure as the joint of the scanner table to the printer side plate of the existing model. Thus, the finisher front and rear side plates can be accurately set relative to the printer side plates. The joints are not limited to this example if they are newly designable.

The joint of the printer side plates to the scanner table in the existing model serves as the joint of the finisher side plates to add to the scanner table. Thus, the joint of the scanner table of the existing model can remain unchanged in shape. Parts other than the joint, for example, sidewalls, are changeable in height for height adjustment. In the case of designing a new scanner table, new joints between the finisher side plates to add and the scanner table and between the scanner table and the finisher may be designed. Utilizing the structure of the existing model without any change is particularly effective in adding a finisher to an existing model with no finisher function.

The respective joints preferably have a convex shape in order to accurately hold the finisher side plates between the printer side plates and the scanner table with a minimum increase in vertical size.

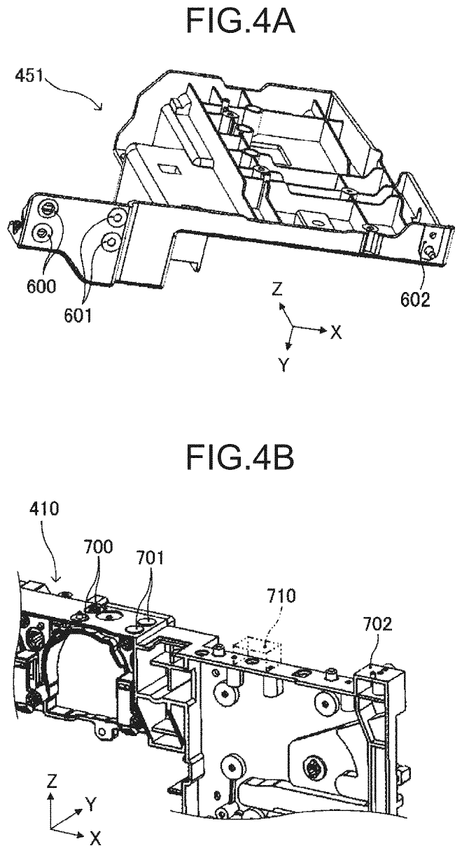

FIG. 4A is a perspective view illustrating the bottom face of the front-right side plate 451 of the finisher. FIG. 4B is a perspective view illustrating a part of the front side plate 410 of the printer to which the front-right side plate 451 is joined. The front-right plate 451 and the front side plate 410 are joined together by contact between protrusions. Specifically, protrusions 600, 601, and 602 of the front-right plate 451 come into contact with protrusions 700, 701, and 702 of the front side plate 410. The protrusions are brought in contact with each other for the following reasons. In the case of resin molding, setting a joint in a region corresponding to the entire opposing surface makes it difficult to mold the side plates since the entire joint surface is to be accurately formed. Meanwhile, partially providing a protrusion with accuracy can facilitate molding. In the case of molding other than resin molding, processing cost can be reduced.

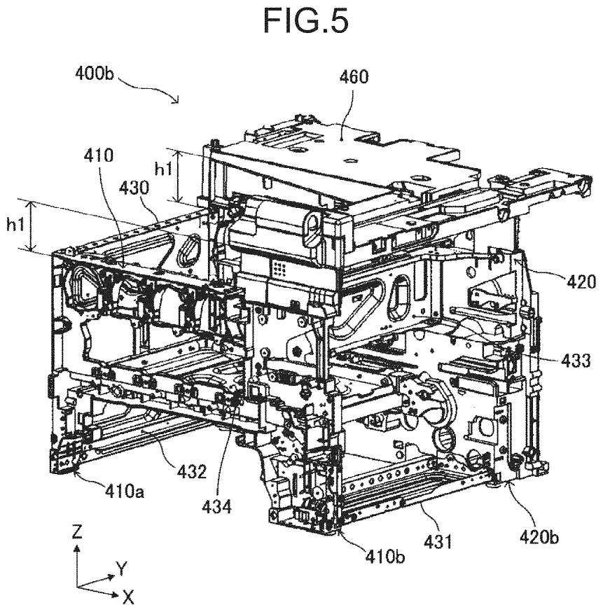

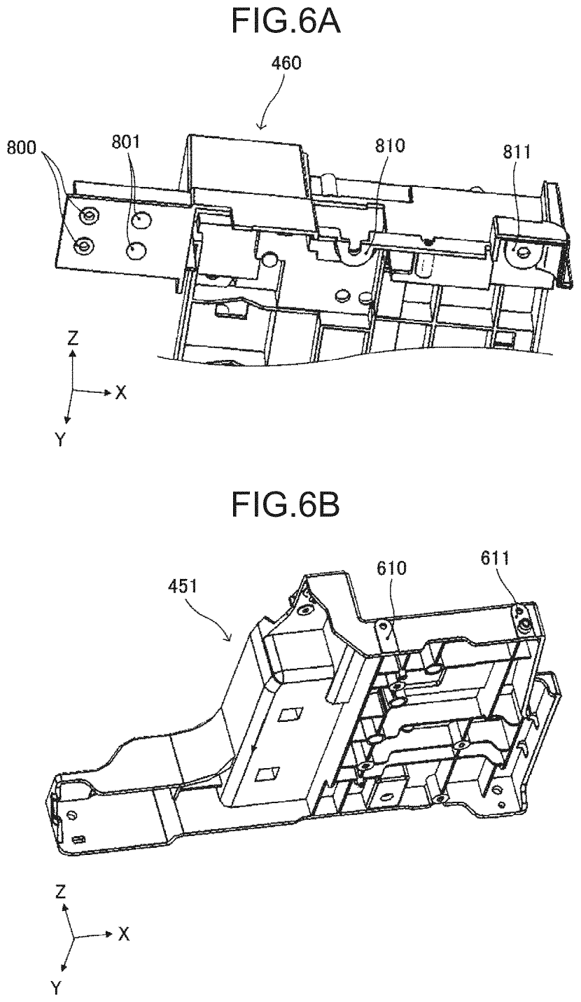

FIG. 5 is a perspective view illustrating a structure of an existing model without a finisher function. The existing model includes the scanner table located above the printer side plate. The scanner table is accurately positioned so that the printer side plate and the scanner table are joined together through partial protrusions set with accuracy. A member 431 serves to couple the front side plate 410 and the rear side plate 420 of the printer together through the next stay member. FIG. 6A is a perspective view illustrating the bottom part of the scanner table 460 of an existing model. The bottom part is provided with protrusions 800, 801, and 811 (810 is not a protrusion) that contact with and couple to the protrusions 700, 701, and 702 of the front side plate 410 illustrated in FIG. 4B. The front-right plate 451 of the finisher can be accurately held with respect to the front side plate 410 of the printer by using the protrusions 800, 801, and 811 for joining the protrusions 700, 701, and 702 of the front side plates 410 and the front-right plate 451.

In the example of FIG. 5, the sidewalls of the scanner table are higher in height by a height h1 than the scanner table of the device in FIG. 2. FIG. 2 illustrates an example of using a scanner table changed in height.

FIG. 6B is a perspective view illustrating a top part of the added front-right side plate 451 of the finisher. The top part is provided with protrusions 610 and 611 to join to the scanner table 460. Among the protrusions, the protrusion 611 at one end is joined to the protrusion 811 of the scanner table 460 illustrated in FIG. 6A. The protrusions 800 and 801 in FIG. 6A are suspended in the air from the added front-right side plate 451. In designing a new scanner table, the suspended protrusions 800 and 801 may be omitted or may be maintained to join to the protrusions 700 and 701 of the front side plate 410, for the purpose of sharing the parts and components with models including no additional front-right plate 451.

As illustrated in FIG. 6B, when the top part of the front-right side plate 451 to add is provided with a second protrusion 610, the scanner table is also provided with an additional, corresponding protrusion 810. In the case of sharing the front-right side plate 451 with a model directly set with the scanner table including the additional protrusion 810, the front-right side plate 451 is provided with an additional, corresponding protrusion 710 as indicated by the virtual alternate long and two short dashes line in FIG. 4B.

The above has described the joints among the front side plate 410, the front-right side plate 451, and the scanner table 460. A joint structure between the front side plate 410 and the rear side plate 452 or the front-left side plate 450 of the finisher can be formed in the same manner. Specifically, three reference points for three-point installation, for example, the protrusions 702, 602, 611, and 811 on the front-right side are preferably aligned straight in a vertical direction. The same applies to the installation points of the rear right and left side plate. This arrangement makes it easier to accurately maintain the height and levelness including a load balance at the same level irrespective of addition or no addition of the paper processing unit. Owing to such a joint structure, the side plates of the finisher can be additionally inserted between the printer side plate and the scanner table accurately with a minimum increase in vertical size.

In addition, it is preferable that the scanner unit 200 be installed on the scanner table 460 in alignment with the straight line. That is, the joint between the housing of the printer and the housing of the paper processing unit preferably coincides in position with the joint between the housing of the paper processing unit and the housing of the reader, in a plane viewed from vertically above. Furthermore, the center (installation part) of the three-point installation of the feet of the front side plate 410 and the rear side plate 420 is preferably set on the above straight line. Most preferably, the joints and installation positions of the respective devices are all aligned in a vertical direction.

FIG. 7 is a perspective view of the copier 1 without an exterior cover, contacting the scanner unit 200. The front-left side plate 450 and the front-right side plate 451 of the finisher are independent or horizontally separated from each other with a gap. Thus, the finisher body is horizontally held in this state, thereby eliminating the necessity for preparing a horizontally long side plate. That is, separately forming the right and left side plates eliminates the necessity for creating a larger mold and also enables decrease in size of a molding machine, preventing cost increase.

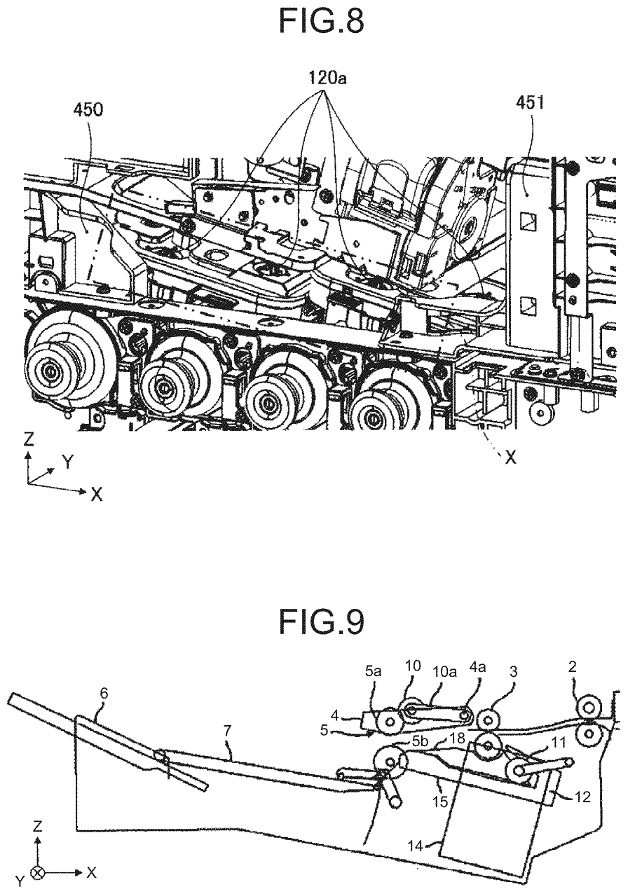

FIG. 8 is an enlarged view of near the area between the front-left side plate 450 and the front-right side plate 451 of the finisher. There is a vacant region X between both the front side plates, which can contribute to improvement in maintainability of the writing unit 120 and the other units located under the finisher. Specifically, the writing unit 120 includes two-color optical scanning units, as illustrated in FIG. 1, provided with four adjustment knobs 120a in total. These knobs 120a are intended for optical-path adjustment. By turning the knobs, the optical path for writing can be adjusted. There is a space in the center of the finisher due to the separation of the front-right and left side plates, which allows the service staff to easily reach the writing unit located under the finisher, improving the maintainability. The region X is generally covered with a cover.

FIG. 9 illustrates a schematic structure of a post-processing unit, as described in Japanese Unexamined Patent Application Publication No. 2012-20863. This post processing unit can be used as the finisher unit 182 of the present embodiment. The finisher unit 182 is not limited thereto, and various kinds of paper processing units can be installed between the printer and the reader in place of the finisher unit 182. The housing of the paper processing unit can be similar to the housing of the finisher unit 182.

### Stapled Paper Ejection Mode

Sheets of paper are conveyed through an inlet roller pair 2 and a staple-ejection roller pair 3 in this order. The paper sheet falls on a staple tray 15, and then a supporting member 10a is rotated counterclockwise about an axis 4a to bring a striking roller 10 in contact with the front side of the paper sheet on the staple tray 15. The striking roller 10 and a rear-end returning roller 11 are rotated counterclockwise to send the paper sheet toward a rear-end reference fence 12 and push the rear end of the paper sheet against the rear-end reference fence 12, thereby aligning the longitudinal side of the paper sheet. Above the staple tray 15, a pair of jogger fences 13 is placed on both sides of the width of the paper sheet. In standby state, the jogger fences 13 are spaced apart from each other with wider spacing than the paper width. The jogger fences 13 are then moved from the standby position to approach each other along the paper width, thereby aligning the lateral side of the sheets stacked on the staple tray 15.

In continuous printing the above operation is repeated till the last sheet of paper. After the last sheet is stacked on the staple tray 15, a bundle of sheets on the staple tray 15 is subjected to binding by a stapler 14. After binding, an ejection opening/closing guide plate 4 is rotated about the axis 4a counterclockwise to bring an upper ejection roller 5a in contact with a lower ejection roller 5b to hold the bundle of sheets in-between the ejection roller pair 5. The ejection roller pair 5 is rotated to eject the bundle of sheets to a paper ejection tray 6. The paper ejection tray 6 rotatably supports an ejection-tray mover 7, and the ejection-tray mover 7 is movable upward and downward on the rear end of sheets depending on the number of stacked sheets of paper. When the ejection roller pair 5 ejects the bundle of sheets to the paper ejection tray 6, the ejection-tray mover 7 temporarily moves downward, and a rear-end pressing member 90, retracted not to obstruct paper ejection when the bundle of sheets come off from the ejection roller pair 5, presses the rear end of the bundle of sheets. The ejection-tray mover 7 is moved upward while the rear end of the bundle of sheets is pressed by the rear-end pressing member 90.

### Straight Paper Ejection Mode

Sheets of paper are conveyed through the inlet roller pair 2 and the staple-ejection roller pair 3 in this order. The ejection opening/closing guide plate 4 is rotated about the axis 4a counterclockwise to bring the upper ejection roller 5a in contact with the lower ejection roller 5b. The ejection roller pair 5 works to hold and convey the paper sheets and eject them to the paper ejection tray 6. Moreover, for ejecting the sheets to the paper ejection tray 6, the ejection-tray mover 7 temporarily moves downward for every several sheets, and the rear-end pressing member 90, retracted not to obstruct paper ejection when the bundle of sheets come off from the ejection roller pair 5, presses the rear end of the sheet. The ejection-tray mover 7 moves upward while the rear end of the sheet is pressed by the rear-end pressing member 90. The rear-end pressing member 90 operates per sheet. The rear-end pressing member 90 detects the height of the sheets of paper ejected on the paper ejection tray 6. In sorting the sheets of paper, the staple-ejection roller pair 3 is movable by a given amount in a vertical direction, that is, direction perpendicular to a paper conveying direction of the staple-ejection roller pair 3.

The present embodiment described above is merely exemplary, and various modifications can be applied thereto.

According to the present invention, it is possible to provide an image processing apparatus including a printer with common specifications, an overall height of which is set according to the height of a paper processing unit.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

What is claimed is:

1. A body structure of an image forming apparatus comprising a printer, a reader, and a paper processing unit located between the printer and the reader, the body structure comprising
a housing for the paper processing unit, independently provided above a housing of the printer.

2. The body structure according to claim 1, further comprising
a housing for the reader, independently provided above the housing for the paper processing unit.

3. The body structure according to claim 2, wherein
in a plane as viewed from vertically above, a joint between the housing for the paper processing unit and the housing of the printer matches in position with a joint between the housing for the paper processing unit and the housing for the reader.

4. The body structure according to claim 2, wherein
the joint of the housing of the printer to the housing for the paper processing unit while not housing the paper processing unit is joinable to the housing for the reader.

5. The body structure according to claim 3, wherein
in a plane as viewed from vertically above, the joints and an installation part of the body structure on a floor match in position with each other.

6. The body structure according to claim 2, wherein
the housing for the paper processing unit includes front side plates which are independent and spaced apart from each other in a horizontal direction.

7. The body structure according to claim 1, wherein
the paper processing unit functions as a finisher.

8. An image forming apparatus comprising the body structure according to claim 1.
